(19) United States
(12) Patent Application Publication
(10) Pub. No.: US 2025/0309316 A1
(43) Pub. Date: Oct. 2, 2025

(54) FUEL CELL STACK

(71) Applicant: Honda Motor Co., Ltd., Tokyo (JP)

(72) Inventors: Naoki Tanaka, Saitama (JP); Takuma Nozaki, Saitama (JP)

(21) Appl. No.: 19/062,015

(22) Filed: Feb. 25, 2025

(30) Foreign Application Priority Data
Mar. 28, 2024 (JP) 2024-052969

(51) Int. Cl. H01M 8/2484; H01M 8/2475

(52) U.S. Cl. CPC H01M 8/2484; H01M 8/2475

(57) ABSTRACT

A fuel cell stack including a cell stacked body, a case surrounding the cell stacked body, a closing part disposed adjacent to the cell stacked body and attached to the case to close an opening in an end surface of the case, and partition members to divide a space inside the case and outside the cell stacked body into subspaces including a first and second spaces. A first air port of one of an air inlet and air outlet is provided in the closing part, a second air port of another the air inlet and air outlet is provided in the case to communicate with either the first space or the second space, and the closing part includes a passage forming portion configured to form a communication flow path connecting the first air port, the first space and the second space.

### CROSS-REFERENCE TO RELATED APPLICATION

This application is based upon and claims the benefit of priority from Japanese Patent Application No. 2024-052969 filed on Mar. 28, 2024, the content of which is incorporated herein by reference.

### BACKGROUND OF THE INVENTION

### Field of the Invention

This invention relates to a fuel cell stack having a ventilation function.

### Description of the Related Art

In recent years, technological developments have been made on a fuel cell that contribute to energy efficiency in order to ensure access to energy that is affordable, reliable, sustainable and advanced by more people. As a technology related to this type of a fuel cell, a conventional technology is known that ventilates a case in which the fuel cell is housed. Such a technology is described, for example, in Japanese Unexamined Patent Publication No. 2006-302606 (JP 2006-302606 A). The case described in JP 2006-302606 A is provided with an air intake and an air outlet, and is configured to allow air taken in from the outside through the air intake to pass through the case and be discharged from the air outlet.

In this type of fuel cell stack, the interior of the case may be divided into a plurality of spaces, making it difficult to ventilate the entire interior with the airflow taken in through the air intake.

### SUMMARY OF THE INVENTION

An aspect of the present invention is a fuel cell stack including: a cell stacked body including a plurality of power generation cells stacked in a predetermined direction; a case configured to surround the cell stacked body; a closing part disposed adjacent to an end surface of the cell stacked body in the predetermined direction and attached to an end portion of the case in the predetermined direction to close an opening in an end surface of the case in the predetermined direction; and a plurality of partition members extending in the predetermined direction so as to divide an space inside the case and outside the cell stacked body, into a plurality of subspaces including a first space and a second space. A first air port is provided in the closing part, a second air port is provided in the case to communicate with either the first space or the second space, the first air port is one of an air inlet through which air flows into the space from an outside and an air outlet through which air flows out of the space to the outside, the second air port is another of the air inlet and the air outlet, and the closing part includes a passage forming portion configured to form a communication flow path connecting the first air port, the first space and the second space.

### BRIEF DESCRIPTION OF THE DRAWINGS

The objects, features, and advantages of the present invention will become clearer from the following description of embodiments in relation to the attached drawings, in which:

FIG. 1 is a perspective view schematically showing an overall configuration of a fuel cell stack according to an embodiment of the present invention;

FIG. 2 is a cross-sectional view taken along line II-II in FIG. 1;

FIG. 3 is a cross-sectional view taken along line III-III in FIG. 1;

FIG. 4 is a cross-sectional view taken along line IV-IV in FIG. 3;

FIG. 5 is a cross-sectional view taken along line V-V in FIG. 4;

FIG. 6 is a cross-sectional view taken along line VI-VI in FIG. 4;

FIG. 7 is an enlarged view of a VII portion in FIG. 4; and

FIG. 8 is a diagram schematically illustrating a flow of cooling air by the fuel cell stack according to the embodiment of the present invention.

### DETAILED DESCRIPTION OF THE INVENTION

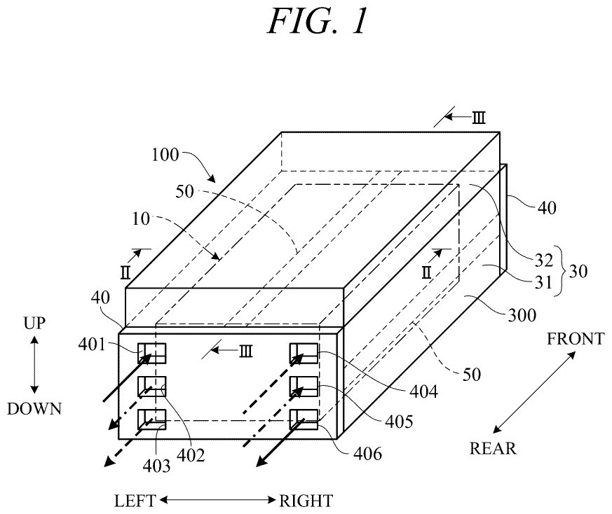

Hereinafter, an embodiment of the present invention will be described with reference to FIGS. 1 to 8. A fuel cell stack according to the embodiment of the present invention is a main component of a fuel cell. A fuel cell is mounted on, for example, a vehicle and can generate electric power for driving the vehicle. The fuel cell can be mounted in a moving body, such as an aircraft or a ship, other than a vehicle and a robot, and various industrial machines.

FIG. 1 is a perspective view schematically illustrating an overall configuration of a fuel cell stack 100 according to the embodiment of the present invention. Hereinafter, for the sake of convenience, three-axis directions orthogonal to each other as illustrated in the drawing are defined as a front-rear direction, a left-right direction, and an up-down direction, and a configuration of each unit will be described according to such definitions. The lower side in the up-down direction in FIG. 1 corresponds to the direction of gravity. The front-rear direction in FIG. 1 corresponds to the stacking direction of the fuel cell stack 100. The front-rear direction and the left-right direction in FIG. 1 are not necessarily identical to a front-rear direction and a left-right direction of the vehicle.

As illustrated in FIG. 1, the fuel cell stack 100 includes a cell stacked body 10, end units 40 disposed at both ends in the front-rear direction of the cell stacked body 10, and a case 30 disposed around the cell stacked body 10, and has a substantially rectangular parallelepiped shape as a whole. A length of the fuel cell stack 100 in the left-right direction is longer than a length of the fuel cell stack 100 in the up-down direction.

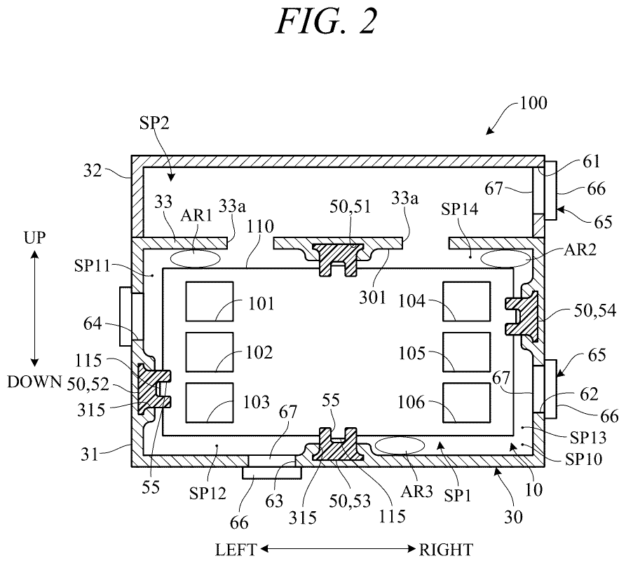

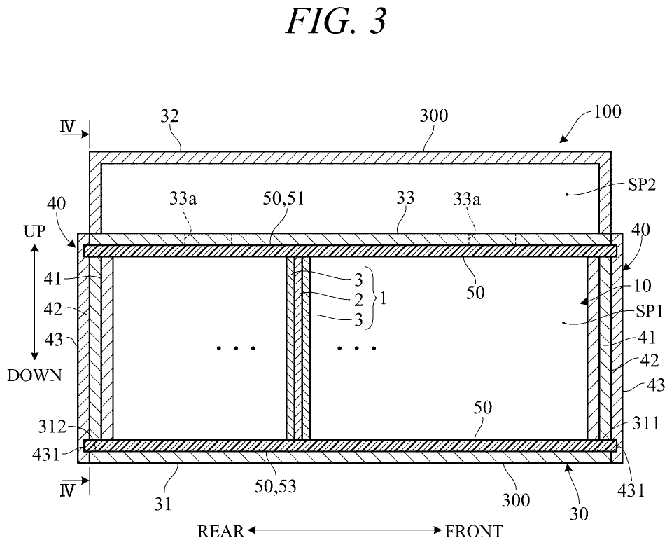

FIG. 2 is a cross-sectional view taken along line II-II of FIG. 1, and FIG. 3 is a cross-sectional view taken along line III-III of FIG. 1. As illustrated in FIGS. 1 to 3, the case 30 includes a lower case 31 forming a lower space SP1 having a substantially rectangular parallelepiped shape, and an upper case 32 forming an upper space SP2 having a substantially rectangular parallelepiped shape. The upper case 32 is provided on the upper portion of the lower case 31 via a partition wall 33. The case 30 is formed by a plurality of side walls 300 extending in the up-down direction or a horizontal direction. The side wall 300 is made of metal such as aluminum or iron.

The cell stacked body 10 is accommodated in the lower space SP1. In a state where the cell stacked body 10 is accommodated, a substantially frame-shaped surplus space SP10 is formed between an inner wall surface 301 of the side wall 300 and an outer side surface 110 of the cell stacked body 10. Although not illustrated, a control unit (for example, a voltage control unit) that controls a fuel cell and the like are accommodated in the upper space SP2. A through-hole 33a penetrating in the up-down direction is open in the partition wall 33, and the lower space SP1 (strictly, a part of the lower space SP1 as described later) and the upper space SP2 communicate with each other via the through-hole 33a.

The case 30 is formed by a plurality of side walls 300 extending in the horizontal direction (front-rear direction, left-right direction) or the up-down direction. As illustrated in FIG. 3, the front surface and the rear surface of the lower case 31 are opened. Therefore, openings 311 and 312 are provided on the front surface and the rear surface of the lower case 31, and the openings 311 and 312 is closed by a pair of front and rear end units 40.

The pair of end units 40 and 40 include a pair of terminal plates 41 and 41 disposed adjacent to the front end surface and the rear end surface of the cell stacked body 10, a pair of insulating plates 42 and 42 disposed adjacent to the pair of terminal plates 41 and 41 and outside the pair of terminal plates 41 and 41 in the front-rear direction, and a pair of end plates 43 and 43 disposed adjacent to the pair of insulating plates 42 and 42 and outside the pair of insulating plates 42 and 42 in the front-rear direction.

The terminal plate 41 is a substantially rectangular plate-shaped member made of metal, and has a terminal portion for extracting electric power generated by an electrochemical reaction in the cell stacked body 10. The insulating plate 42 is a substantially rectangular plate-shaped member made of non-conductive resin or rubber, and electrically insulates the terminal plate 41 from the end plate 43. The end plate 43 is a substantially rectangular plate-shaped member made of metal or resin having high strength. The terminal plate 41 and the insulating plate 42 are disposed inside the lower case 31 with a gap between their outer peripheral edges and the inner wall surface of the lower case 31. The pair of end plates 43 and 43 are fastened to the front end surface and the rear end surface of the lower case 31 by bolts (not illustrated).

The cell stacked body 10 includes a plurality of power generation cells 1 (in FIG. 3, for convenience, a single power generation cell 1 is illustrated) disposed in the lower space SP1. The power generation cell 1 has a unitized electrode assembly (hereinafter, referred to as a “UEA”) 2 including a joint body (a membrane electrode assembly) that includes an electrolyte membrane and electrodes, and separators 3 and 3 arranged on both sides in the front-rear direction of the UEA 2. The UEA 2 and the separator 3 are alternately arranged in the front-rear direction. The UEA 2 can also be referred to as a membrane electrode structure.

The separator 3 is configured by joining a pair of corrugated plates (front plate and rear plate) made of stainless steel, titanium, titanium alloy, etc. An anode flow path through which fuel gas containing hydrogen flows is formed between the rear plate and the UEA 2. A cathode flow path through which oxidant gas containing oxygen (for example, air) flows is formed between the front plate and the UEA 2. A cooling flow path through which a cooling medium flows is formed between the pair of plates.

An electrolyte membrane of the UEA 2 is, for example, a solid polymer electrolyte membrane. An anode electrode has an electrode catalyst layer formed on the front surface of the electrolyte membrane and served as a reaction field for electrode reaction, and a gas diffusion layer formed on the front surface of the electrode catalyst layer to spread and supply the fuel gas. A cathode electrode has an electrode catalyst layer formed on the rear surface of the electrolyte membrane and served as a reaction field for electrode reaction, and a gas diffusion layer formed on the rear surface of the electrode catalyst layer to spread and supply the oxidant gas.

In the anode electrode, the fuel gas (hydrogen) supplied through the anode flow path and the gas diffusion layer is ionized by an action of a catalyst, passes through the electrolyte membrane, and moves to the cathode electrode side. Electrons generated at this time pass through an external circuit and are extracted as electric energy. In the cathode electrode, an oxidant gas supplied via the cathode flow path and the gas diffusion layer reacts with hydrogen ions guided from the anode electrode and electrons moved from the anode electrode to generate water. The generated water gives an appropriate humidity to the electrolyte membrane, and excess water is discharged to an outside of the UEA 2 along the gas flow.

As illustrated in FIG. 1, in the rear end unit 40, a plurality of through-holes 401 to 406 penetrating the rear end unit in the front-rear direction are opened. In the front end unit 40, the through-holes 401 to 406 are not opened. As shown in FIG. 2, a plurality of through-holes 101 to 106 are formed in the cell stacked body 10 at positions corresponding to the through-holes 401 to 406. The through-holes 101 to 106 include through-holes provided in the UEA 2 and through-holes provided in the separator 3. The through-holes 101 to 106 include through holes formed in the UEA 2 and through-holes formed in the separator 3.

The fuel gas is supplied to the fuel cell stack 100 through the through-hole 102a, as shown by an arrow of the solid line in FIG. 1. This fuel gas is guided to the anode flow path of each of the power generation cells 1 through the through-hole 401 of the cell stacked body 10. The fuel gas after passing through the anode flow path is discharged from the through-hole 406 through the through-hole 106, as shown by an arrow of the solid line in FIG. 1.

The oxidant gas is supplied to the fuel cell stack 100 through the through-hole 404, as shown by an arrow of the dotted line in FIG. 1. This oxidant gas is guided to the cathode flow path of each of the power generation cells 1 through the through-hole 104 of the cell stacked body 10. The oxidant gas after passing through the cathode flow path is discharged from the through-hole 403 through the through-hole 103, as shown by an arrow of the dotted line in FIG. 1.

The cooling medium is supplied to the fuel cell stack 100 through the through-hole 405, as shown by an arrow of the one-dot chain line in FIG. 1. This cooling medium is guided to the cooling flow path of each of the power generation cells 1 through the through-hole 105 of the cell stacked body 10. The cooling medium after passing through the cooling flow path is discharged from the through-hole 402 through the through-hole 102, as shown by an arrow of the one-dot chain line in FIG. 1.

As illustrated in FIGS. 1 and 2, a substantially rod-shaped or plate-shaped guide member 50 extending in the front-rear direction is interposed between the outer side surface 110 of the cell stacked body 10 and the inner wall surface 301 of the side wall 300 of the lower case 31. Specifically, as illustrated in FIG. 2, an upper guide member 51, a left guide member 52, a lower guide member 53, and a right guide member 54 are attached to the inner wall surfaces 301 of the upper, left, lower, and right side walls 300 of the lower case 31, respectively. The plurality of guide members 50 (51 to 54) have the same configuration.

The guide member 50 is fitted into a recessed portion 315 provided on the inner wall surface 301 of the side wall 300. As illustrated in FIG. 3, the guide member 50 extends beyond the openings 311 and 312 of the lower case 31 in the front-rear direction. A front end and a rear end of the guide member 50 are fitted into fitting portions 431 (a recessed portion or a through-hole) provided in the end plates 43. Accordingly, the guide member 50 is fixed to the case 30.

As illustrated in FIG. 2, the guide member 50 protrudes toward the outer side surface 110 of the cell stacked body 10, and a concave engagement recessed portion 55 is provided at the distal end of the guide member 50. On the outer side surface 110 of the cell stacked body 10, an engagement protrusion portion 115 is provided corresponding to the engagement recessed portion 55. The engagement protrusion portion 115 engages with the engagement recessed portion 55, whereby the cell stacked body 10 is positioned on the case 30 via the guide members 50.

When such a guide member 50 is provided, the substantially frame-shaped surplus space SP10 between the inner wall surface 301 of the side wall 300 and the outer side surface 110 of the cell stacked body 10 is divided into a plurality of spaces via the guide members 50. That is, the space is divided into an upper left space SP11, a lower left space SP12, an upper right space SP14, and a lower right space SP13. The upper left space SP11 and the upper right space SP14 communicate with the upper space SP2 via the through-hole 33a.

The upper left space SP11 and the upper right space SP14 communicate with each other via the upper space SP2. Meanwhile, communication between the upper left space SP11, the lower left space SP12, and the lower right space SP13, and communication between the upper right space SP14, the lower right space SP13, and the lower left space SP12 are blocked by the guide members 50. Therefore, there is no gas flow between these spaces, or there is only a slight gas flow through gaps between the guide member 50, and the side wall 300 and the cell stacked body 10.

Incidentally, a gas flow path (anode flow path, cathode flow path) of the cell stacked body 10 is sealed by a seal member provided between the UEA 2 and the separator 3 so as to surround the gas flow path. The seal member is made of flexible rubber, resin, or the like, and is in close contact with the surfaces of the UEA 2 and the separator 3 to ensure airtightness. A certain degree of gas leaks from the inside of the cell stacked body 10 through such a seal member. The leaked gas is accumulated in the surplus space SP10. Therefore, the concentration of a hydrogen gas contained in a fuel gas in the surplus space SP10 may increase.

In order to suppress such an increase in the concentration of the hydrogen gas, specifically, a ventilator is provided in the fuel cell stack 100 of the present embodiment so as to suppress the concentration of the hydrogen gas to be less than a predetermined value. The predetermined value is, for example, a flammability limit (the lower limit concentration of the burning range) of the hydrogen gas or a value lower than the flammability limit. Hereinafter, a configuration of the ventilator will be described.

As illustrated in FIG. 2, the case 30 is provided with a plurality of ventilation ports 61 to 64 penetrating the side wall 300. The ventilation port 61 is provided in the right side wall 300 of the upper case 32, and the upper space SP2 in the case and an external space of the fuel cell stack 100 communicate with each other via the ventilation port 61. The ventilation port 62 is provided in the right side wall 300 of the lower case 31, and the lower right space SP13 and the external space communicate with each other via the ventilation port 62. The ventilation port 63 is provided in the lower side wall 300 of the lower case 31, and the lower left space SP12 and the external space communicate with each other via the ventilation port 63. The ventilation port 64 is provided on the left side wall 300 of the lower case 31, and the upper left space SP11 and the external space communicate with each other via the ventilation port 64. The ventilation ports 61 to 64 are provided, for example, at the center of the case 30 in the front-rear direction.

Each of the ventilation ports 61 to 64 is provided with a filter unit 65. The filter unit 65 includes a cover 66 attached to the side wall from the outside of the side wall 300 with a bolt or the like so as to cover the ventilation ports 61 to 64, and a filter 67 fixedly provided on the cover 66 so as to shield the ventilation ports 61 to 64. The cover 66 has a mesh portion and a louver portion that cover the ventilation ports 61 to 64, and prevents intrusion of relatively large foreign matter into the case 30 so as to protect the filter 67. The filter 67 is an air filter, and removes dust and the like from passing gas, particularly air flowing into the case 30 from the outside, thereby preventing intrusion of dust and the like into the case 30 so as to protect the cell stacked body 10.

Since a hydrogen gas has a specific gravity smaller than that of air, the hydrogen gas leaking from the cell stacked body 10 rises in the surplus space SP10. With such a flow of the hydrogen gas, it is possible to discharge the hydrogen gas to the external space via a ventilation port (for example, the ventilation port 61) by natural ventilation. Accordingly, the inside of the case 30 can be ventilated.

However, the flow due to the natural ventilation does not occur over the entire surplus space SP10. For example, in the regions AR1, AR2, and AR3 in FIG. 2, the flow due to the natural ventilation is less likely to occur, and the hydrogen gas is likely to be accumulated in these regions AR1, AR2, and AR3. In this regard, in order to satisfactorily discharge the hydrogen gas in the entire region of the surplus space SP10, the present embodiment further configures the ventilator as follows.

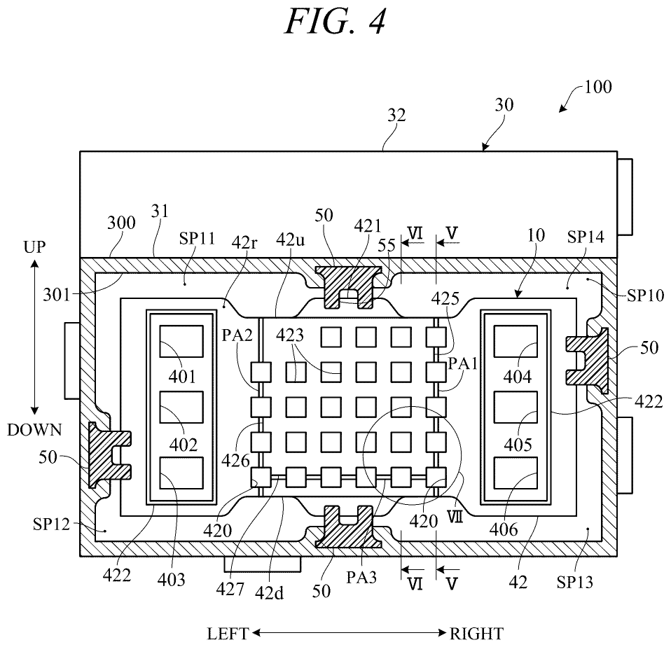

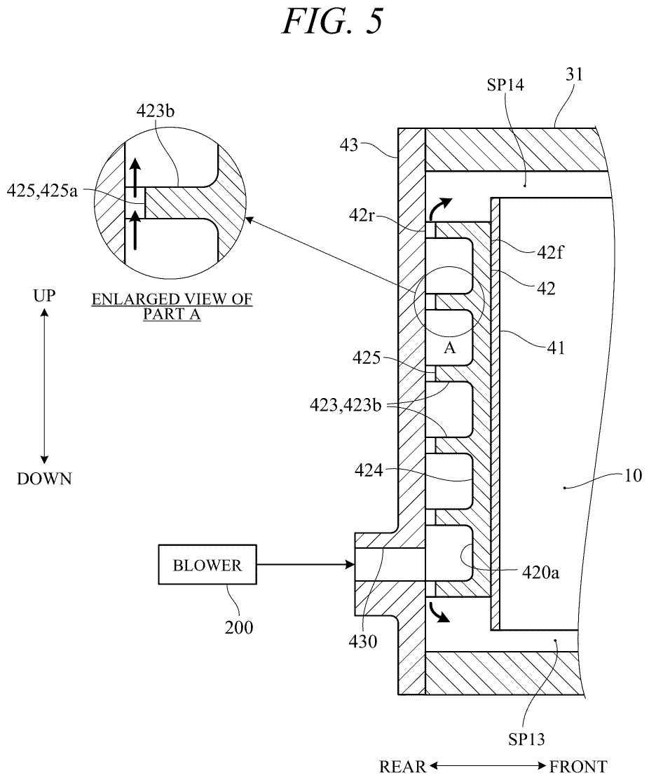

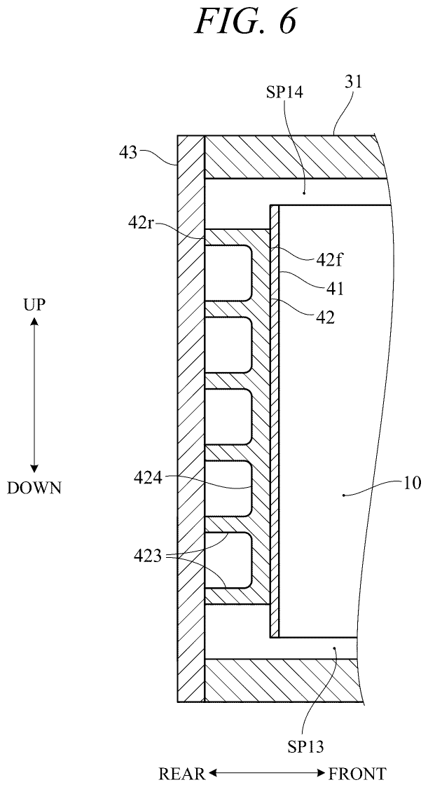

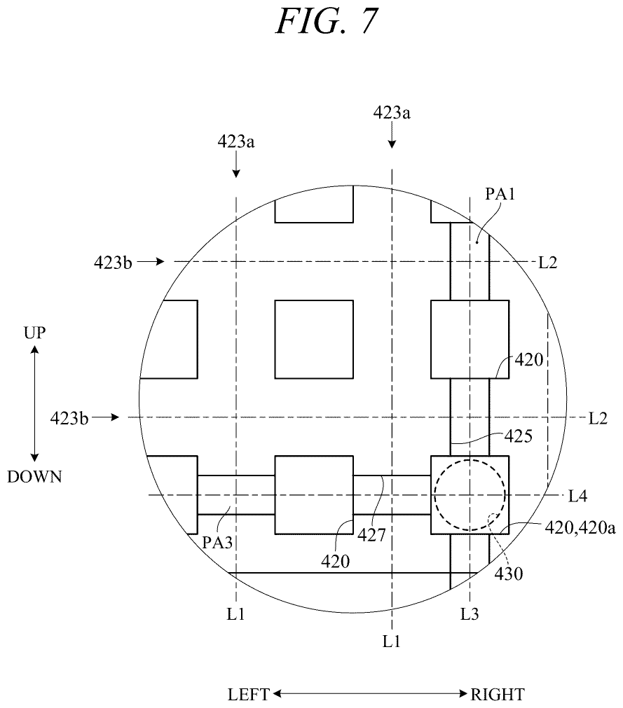

FIG. 4 is a cross-sectional view taken along line IV-IV of FIG. 3. FIG. 4 includes a rear view of the insulating plate 42 on the rear side. FIG. 5 is a cross-sectional view taken along line V-V of FIG. 4 (a cross-sectional view taken along a reference line L3 of FIG. 7), and FIG. 6 is a cross-sectional view taken along line VI-VI of FIG. 4. FIGS. 5 and 6 also illustrate the end plate 43 on the rear side. As illustrated in FIG. 4, an engagement protrusion portion 421 similar to the cell stacked body 10 is provided on the outer side surface of the insulating plate 42, and the engagement protrusion portion 421 is engaged with the engagement recessed portion 55 of the guide member 50. Between the inner wall surface 301 of the side wall 300 of the lower case 31 and the outer side surface of the insulating plate 42, the spaces SP11 to SP14 (FIG. 2) between the lower case 31 and the cell stacked body 10 exist beyond the cell stacked body 10 in the front-rear direction.

As illustrated in FIG. 6, the insulating plate 42 has a front surface 42f abutting on the terminal plate 41 and a rear surface 42r abutting on the end plate 43. As illustrated in FIG. 4, through-holes 401 to 406 (FIG. 1) which allow the insulating plate 42 to penetrate in the front-rear direction are open in the insulating plate 42. On the rear surface 42r of the insulating plate 42, seal members 422 such as O-rings are attached around the through-holes 401 to 403 and around the through-holes 404 to 406 so as to surround the through-holes 401 to 403 and 404 to 406, respectively. The insulating plate 42 and the end plate 43 are pressed against each other via the seal members 422, whereby the periphery of the through-holes 401 to 406 is sealed from the surplus space SP10 (spaces SP11 to SP14) between the case 30 and the cell stacked body 10. Although not illustrated, seal members may be provided around the through-holes 401 to 406 inside the seal member 422 so that the through-holes 401 to 406 do not communicate with each other.

On the rear surface 42r of the insulating plate 42, a plurality of ribs 423 are provided between the pair of left and right seal members 422 and 422. As illustrated in FIGS. 5 and 6, the rib 423 protrudes rearward from the rear surface of a base portion 424 having a predetermined thickness in the front-rear direction. A distal end surface, that is, as top surface (rear end surface) of the rib 423 becomes a rear surface (rear end surface) 42r of the insulating plate 42, and abuts on the end plate 43.

FIG. 7 is an enlarged view of a VII portion in FIG. 4. As illustrated in FIG. 7, the rib 423 includes a plurality of vertical ribs 423a provided at equal intervals in the left-right direction along a plurality of reference lines L1 extending substantially parallel to each other in the up-down direction, and a plurality of lateral ribs 423b provided at equal intervals in the up-down direction along a plurality of reference lines L2 extending substantially parallel to each other in the left-right direction. The widths of the plurality of vertical ribs 423a in the left-right direction and the widths of the plurality of lateral ribs 423b in the up-down direction are the same.

Accordingly, as illustrated in FIG. 4, the entire rib 423 is formed in a grid shape. By providing the grid-shaped rib 423, the rigidity of the insulating plate 42 made of a resin material or the like can be enhanced. As illustrated in FIG. 7, a plurality of rib recessed portions 420 which have a substantially rectangular shape in plan view and each are surrounded by the ribs 423 are provided inside the grid-shaped ribs 423.

As illustrated in FIG. 4, a plurality of cutouts 425 and 426 traversing the plurality of lateral ribs 423b in the up-down direction are provided at both ends of the plurality of lateral ribs 423b in the left-right direction. Furthermore, a plurality of cutouts 427 traversing the plurality of vertical ribs 423a in the left-right direction are provided at lower ends of the plurality of vertical ribs 423a. FIG. 5 illustrates a configuration of the cutout 425. The configurations (width and depth) of the plurality of cutouts 425 to 427 are the same.

As illustrated in an enlarged view of a portion A in FIG. 5, a bottom surface 425a of the cutout 425 extends substantially parallel to the rear surface 42r of the insulating plate 42. As indicated by an arrow, the cutout 425 is set to have a predetermined depth so as to enable a smooth flow of hydrogen gas via the cutout 425, and is set to have a predetermined width as illustrated in FIG. 7.

As illustrated in FIGS. 4 and 7, the plurality of cutouts 425 are provided from an upper end surface 42u to a lower end surface 42d of the insulating plate 42 along the reference line L3 extending in the up-down direction. The upper right space SP14 and the lower right space SP13 communicate with each other via the plurality of cutouts 425. Therefore, the plurality of cutouts 425 constitute a communication flow path PA1 that allows the spaces SP13 and SP14 to communicate with each other.

As illustrated in FIG. 4, the plurality of cutouts 426 are similarly provided from the upper end surface 42u to the lower end surface 42d of the insulating plate 42 along a reference line (not illustrated) extending in the up-down direction. The upper left space SP11 and the lower left space SP12 communicate with each other via the plurality of cutouts 426. Therefore, the plurality of cutouts 426 constitute a communication flow path PA2 that allows the spaces SP11 and SP12 to communicate with each other.

As illustrated in FIGS. 4 and 7, the plurality of cutouts 427 are provided along a reference line L4 extending in the left-right direction from the rib recessed portion 420 at the right end to the rib recessed portion 420 at the left end. The communication flow path PA1 on the right side and the communication flow path PA2 on the left side communicate with each other via the plurality of cutouts 427. Therefore, the plurality of cutouts 427 constitute a communication flow path PA3 that allows the communication flow paths PA1 and PA2 to communicates with each other. The rib recessed portion 420 at the position where the communication flow paths PA1 and PA3 intersect may be referred to as a communication rib recessed portion 420a (FIG. 7) to be distinguished from the other rib recessed portions 420.

As illustrated in FIG. 5, an air supply port 430 penetrating the end plate 43 in the front-rear direction is open in the end plate 43. The air supply port 430 is provided at a position (a dotted line in FIG. 7) facing the communication rib recessed portion 420a. A blower 200 is connected to the air supply port 430 via, for example, a tube or a pipe, and cooling air is blown from the blower 200 to the air supply port 430. Cooling air may be blown from the blower 200 to the air supply port 430 without passing through a tube or a pipe.

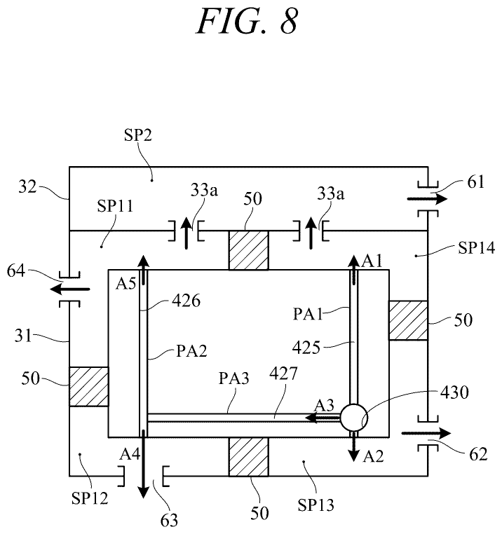

In the present embodiment, the inside of the case 30 is ventilated by forced ventilation for blowing cooling air from the blower 200. FIG. 8 is a diagram schematically illustrating a flow of cooling air. As illustrated in FIG. 8, when cooling air is blown into the fuel cell stack 100 via the air supply port 430, as indicated by arrow A1, a part of the cooling air flows upward toward the upper right space SP14 in the lower case 31 through communication flow path PA1 formed by the cutout 425. Further, the cooling air changes its flow direction forward as indicated by the arrows in FIG. 5, and flows forward through the upper right space SP14. The air in the upper right space SP14 flows through the upper space SP2 in the upper case 32 via the through-hole 33a as indicated by arrows in FIG. 8. Then, by using the ventilation port 61 as an exhaust port, the air flows out to the outside of the case 30 through the ventilation port 61.

In addition, as indicated by an arrow A2 in FIG. 8, a part of the cooling air blown via the air supply port 430 flows downward toward the lower right space SP13 in the lower case 31 through the communication flow path PA1. Further, the cooling air changes its flow direction forward as indicated by the arrows in FIG. 5 and flows forward through the lower right space SP13. By using the ventilation port 62 as an exhaust port, the air in the lower right space SP13 flows out to the outside of the case through the ventilation port 62 as indicated by the arrows in FIG. 8.

Further, as indicated by an arrow A3 in FIG. 8, a part of the cooling air blown via the air supply port 430 passes through the communication flow path PA3 formed by the cutout 427 and flows to the communication flow path PA2 formed by the cutout 426. As indicated by an arrow A4, a part of the cooling air in the communication flow path PA2 flows downward toward the lower left space SP12 in the lower case 31. Further, the cooling air changes its flow direction forward and flows forward through the lower left space SP12. Then, by using the ventilation port 63 as an exhaust port, the air flows out to the outside of the case through the ventilation port 63.

As indicated by an arrow A5 in FIG. 8, the rest of the cooling air in the communication flow path PA2 flows upward toward the upper left space SP11 in the lower case 31. Further, the cooling air changes its flow direction forward and flows forward through the upper left space SP11. The air in the upper left space SP11 flows through the upper space SP2 in the upper case 32 via the through-hole 33a as indicated by arrows. Then, by using the ventilation port 61 as an exhaust port, the air flows out to the outside of the case through the ventilation port 61.

As described above, in the present embodiment, the cooling air flows through the plurality of spaces SP11 to SP14 around the cell stacked body 10 by the forced ventilation in which the cooling air is blown from the single air supply port 430. Therefore, even in a case where the inside of the case 30 is partitioned into the plurality of spaces SP11 to SP14 by the guide members 50, the inside of the case 30 can be sufficiently ventilated, and the hydrogen gas in the spaces SP11 to SP14 can be satisfactorily discharged.

The blower 200 may be driven continuously or may be driven at a predetermined timing. For example, a sensor for detecting the hydrogen concentration in the surplus space SP10 may be provided, and when the hydrogen concentration detected by the sensor becomes a predetermined value or more, a controller may output a control signal to the blower 200 to drive the blower 200.

According to the present embodiment, the following operations and effects are achievable.
(1) The fuel cell stack 100 includes: the cell stacked body 10 that is formed by stacking a plurality of power generation cells 1 in a front-rear direction; the case 30 that surrounds the cell stacked body 10; the end unit 40 that is disposed adjacent to an end surface of the cell stacked body 10 in the front-rear direction and is attached to an end of case 30 in the front-rear direction so as to close the openings 311 and 312 in an end surface of the case 30 in the front-rear direction; and the plurality of guide members 50 that extend in the front-rear direction so as to divide the lower space SP1 between the inner wall surface (inner surface) 301 of the case 30 and the outer side surface 110 of the cell stacked body 10 into the plurality of spaces SP11 to SP14 (FIGS. 1 to 3). The end unit 40 is provided with the air supply port 430 through which air is taken in from the outside (FIG. 5). The case 30 is provided with the ventilation ports 61 to 64 as exhaust ports (FIG. 2). The end unit 40 has the cutouts 425 to 427 forming the communication flow paths PA1 to PA3 that allow the plurality of spaces SP11 to SP14 to communicate with each other (FIG. 8).

With this configuration, in a case where the inside of the case 30 is divided into the plurality of spaces SP11 to SP14 by the guide members 50, the cooling air blown via the air supply port 430 can be supplied to the plurality of spaces SP11 to SP14 via the communication flow paths PA1 to PA3. As a result, the entire surplus space SP10 in the case can be efficiently ventilated, and the hydrogen gas accumulated in the surplus space SP10 can be satisfactorily discharged to the outside.
(2) The end unit 40 includes the conductive terminal plate 41 that is disposed adjacent to the end surface of the cell stacked body 10 in the front-rear direction, the insulating plate 42 that is disposed adjacent to the terminal plate 41, and the end plate 43 that is disposed adjacent to the insulating plate 42 (FIG. 3). A gap is provided between an outer edge of the terminal plate 41 and the inner wall surface 301 of the case 30 and between an outer edge of the insulating plate 42 and the inner wall surface 301 of the case (FIG. 5). The air supply port 430 is provided to penetrate the end plate 43 (FIG. 5). The cutouts 425 to 427 forming the communication flow paths PA1 to PA3 are provided in the insulating plate 42 (FIG. 4). Accordingly, the communication flow paths PA1 to PA3 can be easily formed.
(3) The insulating plate 42 has the front surface 42f facing the terminal plate 41 and the rear surface 42r facing the end plate 43 (FIG. 5). The communication flow path PA1 extends along the rear surface 42r from the upper end surface 42u of the insulating plate 42 facing the upper right space SP14 to the lower end surface 42d of the insulating plate 42 facing the lower right space SP13 (FIGS. 4 and 5). Accordingly, the spaces SP13 and SP14 can easily communicate with each other via the insulating plate 42 of which shape is relatively easily changed, that is, via the cutout 425 of the insulating plate 42.
(4) The insulating plate 42 has the reinforcing rib 423 provided on the rear surface 42r (FIG. 7). The communication flow paths PA1 to PA3 are configured by the cutouts 425 to 427 provided at a top of the rib 423 (FIGS. 4 and 7). Accordingly, since the area of the cutouts 425 to 427 is small, the communication flow paths PA1 to PA3 can be easily formed.
(5) The guide member 50 is a positioning member extending in the front-rear direction, and the cell stacked body 10 has the engagement protrusion portion 115 provided on the outer side surface 110 so as to engage with the engagement recessed portion 55 of the guide member 50 (FIG. 2). Since the guide member 50 is extended in the front-rear direction so as to close the communication between the spaces SP11 to SP14, the guide member 50 can be firmly configured, and the cell stacked body 10 can be stably positioned.
(6) The case 30 includes the lower case 31 forming the lower space SP1, and the upper case 32 communicating with the lower space SP1 and forming the upper space SP2 in an upper portion of the lower case 31 (FIG. 3). The ventilation ports 62 to 64 are provided in the lower case 31, and the ventilation port 61 is provided in the upper case 32 (FIG. 2). Accordingly, the cooling air supplied via the blower 200 can be satisfactorily discharged from the ventilation ports 61 to 64 of the upper case 32 and the lower case 31.

The above embodiments can be modified into various forms. Hereinafter, some modifications will be described. In the above embodiment, the blower 200 blows cooling air into the case 30 to ventilate the inside of the case 30, but it is also possible to ventilate the inside of the case 30 by sucking the air inside the case 30 with a fan or the like. Therefore, in the end unit 40, instead of providing the air supply port 430 (an air inlet) as a first air port to take in air from the outside, it is also possible to provide an air exhaust port (an air outlet) to discharge air to the outside. Additionally, in the case 30, instead of the ventilation ports 61 to 64 (air outlets) functioning as exhaust ports, it is also possible to provide air intakes functioning as air supply ports as a second air port.

In the above embodiment, the communication flow paths PA1 to PA3 are formed by providing cutouts 425 to 427 in the rib 423 provided on the insulating plate 42, but the configuration of a passage forming portion is not limited to the above. Instead of forming the communication flow path on the rear surface 42r (a second surface) of the insulating plate 42 where the rib 423 is provided, it is also possible to form the communication flow path on the front surface 42f (a first surface) of the insulating plate 42. In the above embodiment, the plurality of communication flow paths PA1 to PA3 are formed, but the number of communication flow paths is not limited to the above. In the above embodiment, the communication flow path PA1 is extended from the upper end surface 42u (a first edge portion) of the insulating plate 42 facing the upper right space SP14 to the lower end surface 42d (a second edge portion) of the insulating plate 42 facing the lower right space SP13, but the configuration of a communication flow path is not limited to the above.

In the above embodiment, the plurality of ventilation ports 61 to 64 are provided in the case 30, but it is also possible to provide a single ventilation port. For example, it is also possible to provide only the uppermost ventilation port 61. In the above embodiment, the end unit 40 as a closing part is configured with the terminal plate 41 (a first member) having conductivity, the insulating plate 42 (a second member) having insulation property, and the end plate 43 (a third member), but the configuration of the closing part is not limited to the above. That is, as long as either an air intake or an air outlet is provided, and a passage forming portion that forms a communication flow path communicating a first air port (air supply port 430) with two of the plurality of spaces SP11 to SP14 (a first space, a second space) is provided in the closing part, the configuration of the closing part can be any configuration. The combination of the first space and the second space can be any, such as spaces SP13 and SP14, spaces SP11 and SP12, spaces SP11 and SP14, spaces SP12 and SP13, etc.

In the above embodiment, the surplus space SP10 between the inner wall surface (an inner side surface) 301 of the case 30 and the outer side surface 110 of the cell stacked body 10 is divided into the plurality of spaces SP11 to SP14 by the guide member 50 as a positioning member extending in the predetermined direction, but partition members dividing the space SP10 is not limited to the positioning member. In the above embodiment, the space SP10 is divided into four. That is, it is divided into a first space (e.g., upper right space SP14), a second space (e.g., lower right space SP13), a third space (e.g., upper left space SP11), and a fourth space (lower left space SP12), but as long as it is divided into a plurality of spaces including at least the first space and the second space, the space SP10 may be divided into more than four. In the above embodiment, the communication flow path PA1 (a first communication flow path) and the communication flow path PA2 (a second communication flow path) extend parallel to each other, and the communication flow path PA3 (a third communication flow path) extends orthogonally to the communication flow path PA1, but the direction in which the communication flow path extends is not limited to the above. In the above embodiment, the air supply port 430 is provided facing the intersection portion of the communication flow paths PA1 and PA3, but the position where the air supply port is provided, is not limited to the above.

In the above embodiment, the engagement protrusion portion 115 that engages with the guide member 50 is provided on the outer side surface 110 of the cell stacked body 10, but it is also possible to provide an engagement recessed portion instead of the engagement protrusion portion. Instead of engaging with the guide member 50, it is also possible to fit to it. Therefore, the configuration of a positioning member is not limited to the above, and the configuration of a positioning portion provided on the outer side surface 110 of the cell stacked body 10 is also not limited to the above.

In the above embodiment, the case 30 is configured by the lower case 31 (a first case portion) forming the lower space SP1 and the upper case 32 (a second case portion) forming the upper space SP2 (another space) above the lower case 31, but the configuration of a case is not limited to the above. In the above embodiment, the ventilation ports 61 to 64 are provided in both the upper case 32 and the lower case 31, but it is also possible to provide ventilation ports (air inlet or air outlet) only in the upper case 32 or only in the lower case 31.

The above embodiment can be combined as desired with one or more of the above modifications. The modifications can also be combined with one another.

According to the present invention, it is possible to efficiently ventilate an entire interior of a fuel cell stack.

Above, while the present invention has been described with reference to the preferred embodiments thereof, it will be understood, by those skilled in the art, that various changes and modifications may be made thereto without departing from the scope of the appended claims.

What is claimed is:

1. A fuel cell stack comprising:
a cell stacked body including a plurality of power generation cells stacked in a predetermined direction;
a case configured to surround the cell stacked body;
a closing part disposed adjacent to an end surface of the cell stacked body in the predetermined direction and attached to an end portion of the case in the predetermined direction to close an opening in an end surface of the case in the predetermined direction; and
a plurality of partition members extending in the predetermined direction so as to divide a space inside the case and outside the cell stacked body, into a plurality of subspaces including a first space and a second space, wherein
a first air port is provided in the closing part,
a second air port is provided in the case to communicate with either the first space or the second space,
the first air port is one of an air inlet through which air flows into the space from an outside and an air outlet through which air flows out of the space to the outside,
the second air port is another of the air inlet and the air outlet, and
the closing part includes a passage forming portion configured to form a communication flow path connecting the first air port, the first space and the second space.

2. The fuel cell stack according to claim 1, wherein
the closing part includes a first member with a conductivity disposed adjacent to the end surface of the cell stacked body, a second member with an insulation property disposed adjacent to the first member, and a third member disposed adjacent to the second member,
a gap is provided between an outer peripheral edge of the first member and an inner wall surface of the case and between an outer peripheral edge of the second member and the inner wall surface of the case,
the first air port is provided to penetrate the third member in the predetermined direction, and
the passage forming portion is provided in the second member.

3. The fuel cell stack according to claim 2, wherein
the second member includes a first surface facing the first member and a second surface facing the third member,
the outer peripheral edge of the second member includes a first edge portion facing the first space and a second edge portion facing the second space, and
the communication flow path is provided on the second surface so as to extend from the first edge portion to the second edge portion.

4. The fuel cell stack according to claim 3, wherein
the second member includes a rib provided on the second surface, and
the passage forming portion is configured by a cutout provided at a top of the rib.

5. The fuel cell stack according to claim 1, wherein
each of the plurality of partition members is a positioning member extending in the predetermined direction, and
the cell stacked body includes a positioning portion provided on an outer side surface of the cell stacked body so as to engage with or fit to the positioning member.

6. The fuel cell stack according to claim 1, wherein
the case includes a first case portion forming the space and a second case portion forming another space above the first space so as to communicate with the space, and
the second air port is provided in at least one of the first case portion and the second case portion.

7. The fuel cell stack according to claim 1, wherein
the plurality of subspaces further include a third space and a fourth space,
the plurality of partition members are configured to separate the first space, the second space, the third space, and the fourth space from each other,
the communication flow path is a first communication flow path, and
the closing part further includes another passage forming portion to form a second communication flow path connecting the third space and the fourth space and a third communication flow path connecting the first communication flow path and the second communication flow path.

8. The fuel cell stack according to claim 7, wherein
the first air port is provided facing an intersection portion where the first communication flow path and the third communication flow path intersect.

9. The fuel cell stack according to claim 7, wherein
the second communication flow path extends parallel to the first communication flow path, and
the third communication flow path extends perpendicular to the first communication flow path.
